(19) United States
(12) Patent Application Publication
(10) Pub. No.: US 2024/0399276 A1
(43) Pub. Date: Dec. 5, 2024

(54) WATER PURIFIER AND WATER PURIFIER ASSEMBLY COMPRISING SAME

(71) Applicant: COWAY CO., LTD., Gongju-si (KR)

(72) Inventors: Hyun Kang LEE, Seoul (KR); Hee Joo KANG, Seoul (KR); Yoo Won OH, Seoul (KR); Jong Hwan LEE, Seoul (KR); Hee Do JUNG, Seoul (KR)

(73) Assignee: COWAY CO., LTD., Gongju-si (KR)

(21) Appl. No.: 18/700,390

(22) PCT Filed: Sep. 30, 2022
(86) PCT No.: PCT/KR2022/014827

§ 371 Date: Apr. 11, 2024

(30) Foreign Application Priority Data
Oct. 15, 2021 (KR) 10-2021-0137739
Jul. 25, 2022 (KR) 10-2022-0091753

(51) Int. Cl. B01D 35/30

(52) U.S. Cl. CPC B01D 35/306; B01D 2201/4023

(57) ABSTRACT

A water purifier comprises: a filter case capable of accommodating a plurality of filters; a frame on which the filter case is attached to be separatable; a latch provided on one of the filter case and the frame; and a locking device which can be placed in one of a locking state, in which the filter case is prevented from being separated from the frame, and an unlocking state, in which the filter case is allowed to be separated from the filter case, when the filter case is attached to the frame. The locking device comprises a locking member which is provided on the other of the filter case and the frame, and is interfered with by the latch when placed in the locking state and moves in the direction away from the latch when switching from the locking state to the unlocking state.

### TECHNICAL FIELD

The present disclosure relates to a water purifier and a water purifier assembly including the same.

### BACKGROUND ART

Generally, a water purifier is a device that receives water from a water source such as a tap, filters the water into purified water, and then provides the purified water to a user. Such a water purifier filters the water into the purified water using a filter, and the water filtered by the filter flows along a flow path provided inside the water purifier and then is discharged outside the water purifier.

Meanwhile, the filter installed in the water purifier needs to be replaced with a new filter because filtration performance of the filter deteriorates when used for a certain period of time. Like this, when the filter needs to be replaced, the user separates the filter in use from a water purifier body and reinstalls the new filter into the water purifier body.

Korean Patent Application Publication No. 10-2018-0135265 (hereinafter, referred to as Patent Document 1) entitled “Filter mounting unit and water purifier including the same” of the present applicant discloses a filter member provided to be replaceable from a shelter member and a lever member for fixing the filter member to the shelter member.

However, in Patent Document 1, when the filter member is mounted on the shelter member, a user should rotate the lever member to one side, and when the lever member is not rotated, the filter member interferes with the lever member and cannot be mounted on the shelter member. In addition, when the filter member is mounted on the shelter member in a state where the lever member is rotated to one side, the user should rotate the lever member to the other side, and when the lever member is not rotated to the other side, the lever member cannot fix the filter member to the shelter member.

Accordingly, there is a need for a water purifier in which the lever member can fix the filter member to the shelter member simply by mounting the filter member to the shelter member without even rotating the lever member.

Korean Patent Application Publication No. 10-2020-0126662 (hereinafter, referred to as Patent Document 2) entitled “Water purifier” of the present applicant discloses a filter fixing/separating unit capable of fixing a purified water filter to a water purifier body. The filter fixing/separating unit allows the purified water filter to be mounted on the water purifier body without an operation of the user, and can fix the purified water filter mounted on the water purifier body so that the purified water filter does not come off the water purifier body.

However, in Patent Document 2, the filter fixing/separating units should be provided in plural pieces to fix each of the plurality of purified water filters, and when the plurality of purified water filters are replaced from the water purifier main body, there is inconvenience of operating the plurality of filter fixing/separating units separately. In addition, when the filter fixing/separating units are arranged in accordance with the number of purified water filters, a space for arrangement of a plurality of filter fixing/separating units is required, and the cost increases.

Therefore, there is a need for a water purifier that can fix the purified water filter to the water purifier body even when the number of filter fixing/separating units is less than that of the purified water filters.

### DETAILED DESCRIPTION OF INVENTION

### Technical Problems

In view of the above, one embodiment of the present disclosure provides a water purifier assembly in which a plurality of filters can be replaced at once by simply removing and replacing a filter case accommodating the plurality of filters from a frame.

In addition, one embodiment of the present disclosure provides a water purifier assembly in which a plurality of filters can be fixed to a frame even when the number of locking devices is less than that of the filters.

In addition, one embodiment of the present disclosure provides a water purifier assembly in which filters with similar replacement cycles among a plurality of filters are grouped to be accommodated in one filter case, thereby reducing the inconvenience of having to separate the filter case from the frame for each replacement cycle.

In addition, one embodiment of the present disclosure provides a water purifier assembly in which a connection portion communicating with the filter is arranged to be biased to one side based on an accommodating space, thereby preventing left and right filter cases from being mounted on a frame portion at different positions.

### Technical Solution

In accordance with one embodiment of the present disclosure, a water purifier comprises a filter case configured to accommodate a plurality of filters: a frame on which the filter case is mounted to be separable: a latch provided in any one of the filter case and the frame; and a locking device configured to be placed in any one of a locking state where the filter case is prevented from being separated from the frame and an unlocking state in which the filter case is allowed to be separated from the filter case, when the filter case is mounted on the frame, wherein the locking device includes a locking member that is provided in the other of the filter case and the frame, interferes with the latch when the locking member is in the locking state, and moves in a direction away from the latch when the locking member is switched from the locking state to the unlocking state.

Further, the water purifier further comprises a push member movably supported relative to any one of the filter case and the frame, wherein the locking member moves in the direction away from the latch when the push member is moved toward the locking device, and moves in a direction toward the latch when the push member is moved in a direction away from the locking device.

Further, the push member includes a push body portion and a push guide portion extending from the push body portion toward the locking member and formed such that at least a portion of an upper surface is inclined downward, wherein the locking member includes a locking body portion and a rib portion extending from the locking body portion toward the push member and formed such that at least a portion of a bottom surface is inclined upward, and wherein the rib portion moves in an up-down direction with the bottom surface supported by the upper surface of the push guide portion when the push guide portion moves in a front-rear direction.

Further, the locking device includes an elastic member, wherein the elastic member provides restoring force so that the locking member switches from the unlocking state to the locking state, and the restoring force becomes greater when the locking member is placed in the unlocking state than when placed in the locking state.

Further, the latch includes a wall surface extending upward from an upper surface of the filter case and an inclined surface extending obliquely downward from the wall surface, and the locking member is in surface contact with the wall surface when the locking member is placed in the locking state.

Further, the water purifier assembly comprises a plurality of filters configured to filter water to provide purified water; and a water purifier on which the filter is mounted to be separable, wherein the water purifier includes a filter case configured to accommodate the plurality of filters, a frame on which the filter case is mounted to be separable, a latch provided in any one of the filter case and the frame, and a locking device configured to be placed in any one of a locking state where the filter case is prevented from being separated from the frame and an unlocking state in which the filter case is allowed to be separated from the filter case, when the filter case is mounted on the frame, and wherein the locking device includes a locking member that is provided in the other of the filter case and the frame, interferes with the latch when the locking member is in the locking state, and moves in a direction away from the latch when the locking member is switched from the locking state to the unlocking state.

Further, the filter case further includes a first filter case configured to accommodate a first filter group including some of the plurality of filters and a second filter case configured to accommodate a second filter group including others of the plurality of filters, and wherein an average replacement cycle of the filters of the first filter group is shorter than an average replacement cycle of the filters of the second filter group.

Further, the filter with the longest replacement cycle among the filters in the first filter group has a shorter replacement cycle than the filter with the shortest replacement cycle among the filters in the second filter group.

Further, the filter case includes a first filter case configured to accommodate a first filter group including some of the plurality of filters and a second filter case configured to accommodate a second filter group including others of the plurality of filters, wherein the frame includes a frame portion having a first accommodating space opened toward the front and accommodating the first filter case and a second accommodating space opened toward the front and accommodating the second filter case, a first connection portion disposed to be biased toward one side in the first accommodating space in a left-right direction when viewed from the front and communicating with the filter of the first filter group, and a second connection portion disposed to be biased toward one side in the second accommodating space in the left-right direction when viewed from the front and communicating with the filter of the second filter group, wherein the first connection portion and the second connection portion are disposed on the frame portion so that the first connection portion and the second connection portion are symmetrical to each other with respect to a center of the frame portion when viewed from the front.

Further, the filter case includes a connector portion including a first connector portion connected to any one of the plurality of filters and a second connector portion connected to another one of the plurality of filters, and a housing portion configured to accommodate the plurality of filters and support the first connector portion and the second connector portion, wherein one or more steps are formed in the housing portion, and wherein the first connector portion and the second connector portion are supported by the one or more steps so as to be spaced apart from each other in an up-down direction.

### Effect of Invention

According to one embodiment of the present disclosure, it is possible to replace a plurality of filters at once by simply removing and replacing a single filter case accommodating the plurality of filters from the frame.

Further, according to one embodiment of the present disclosure, it is possible to fix a plurality of filters to a frame even when the number of locking devices is less than that of the filters.

In addition, according to one embodiment of the present disclosure, by grouping filters with similar replacement cycles among a plurality of filters and accommodating the grouped filters in one filter case, it is possible to reduce the inconvenience of separating the filter case from the frame for each replacement cycle.

Further, according to one embodiment of the present disclosure, by arranging the connection portion communicating with the filter to be biased to one side based on an accommodating space, it is possible to prevent left and right filter cases from being mounted on the frame portion at different positions.

### BRIEF DESCRIPTION OF THE DRAWING

FIG. 1 is a perspective view illustrating a water purifier assembly according to one embodiment of the present disclosure.

FIG. 2 is an exploded perspective view of the water purifier assembly of FIG. 1.

FIG. 3 is an exploded perspective view of rear sides of a filter case and a frame illustrated in FIG. 2.

FIG. 4 is a perspective view of a locking device of the water purifier assembly of FIG. 1.

FIG. 5 is an enlarged view of part B of FIG. 3.

FIG. 6 is a front view of the frame of FIG. 2.

FIG. 7 is a cross-sectional view taken along line VII-VII of FIG. 3.

FIG. 8 is a view illustrating a case in which a locking member of FIG. 7 is switched from a locking state to an unlocking state.

FIG. 9 is a view illustrating a case in which the locking member of FIG. 7 switching from the unlocking state to the locking state.

FIG. 10 is an enlarged view of part A of FIG. 2.

### BEST MODE FOR CARRYING OUT THE INVENTION

Hereinafter, specific embodiments for implementing the technical idea of the present disclosure will be described in detail with reference to the drawings.

In addition, when describing the present disclosure, in a case where it is determined that a detailed description of a related known configuration or function may obscure the gist of the present disclosure, the detailed description will be omitted.

In addition, when a component is mentioned as being “connected”, “supported”, “inflowed”, “supplied”, or “flowed” to another component, the component may be directly connected to, supported, inflowed, supplied, or flowed into the other component, but it should be understood that other components may exist therebetween.

The terms used in this specification are merely used to describe specific embodiments and are not intended to limit the disclosure. Singular expressions include plural expressions unless the context clearly dictates otherwise.

Additionally, terms including ordinal numbers, such as first, second, or the like, may be used to describe various components, but the components are not limited by these terms. These terms are used only to distinguish one component from another.

As used herein, the meaning of “including” is to specify a particular feature, area, purified water, step, operation, element, and/or ingredient, and does not exclude the presence or addition of any other specific feature, area, purified water, step, operation, element, component, and/or group.

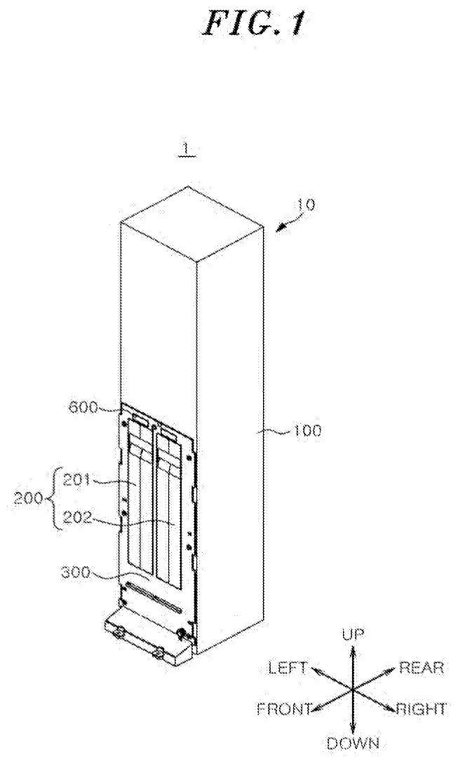

In addition, it should be noted in advance that expressions for directions such as up and down in this specification are explained based on the drawings, and may be expressed differently if the direction of the object in question changes. Meanwhile, in this specification, an up-down direction, a left-right direction, and a front-rear direction may be coordinate axis directions illustrated in FIGS. 1 to 3 and FIG. 6.

Hereinafter, a specific configuration of a water purifier assembly 1 according to one embodiment of the present disclosure will be described with reference to the drawings.

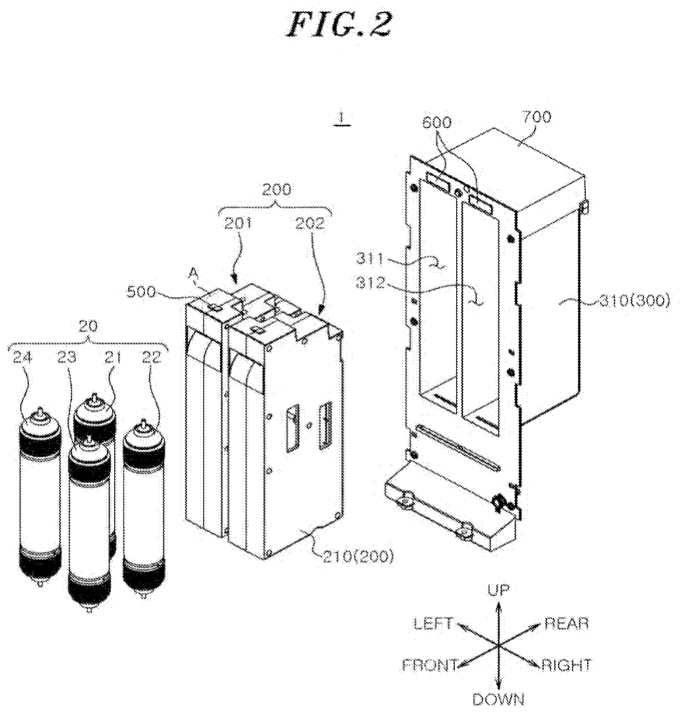

Hereinafter, referring to FIGS. 1 and 2, the water purifier assembly 1 according to one embodiment of the present disclosure may provide clean water to a user by filtering water supplied from outside. For example, the water purifier assembly 1 may receive water from a water source (not illustrated) such as a tap, and filter the supplied water into clean water. The water purifier assembly 1 may include a water purifier 10 and a filter 20.

Referring to FIGS. 2 to 4, when the water purifier 10 is equipped with the filter 20, the water purifier may filter water and provide clean water to the user. This water purifier 10 may include a water purifier body 100, a filter case 200, a frame 300, a locking device 400, a latch 500, a push member 600, and a valve module 700.

The water purifier body 100 may support the frame 300 and configure an external shape of the water purifier 10. The water purifier body 100 may be provided to surround the frame 300.

Referring again to FIG. 2, the filter case 200 may accommodate the filter 20 and be mounted on the frame 300 to be replaceable. For example, the filter case 200 may be mounted on or separated from the frame 300 while accommodating the filter 20. This filter case 200 may accommodate a plurality of filters 20. In addition, when the filter case 200 is mounted on the frame 300, the filter case 200 may be fixed to the frame 300 without being separated from the frame 300 by the locking device 400. A plurality of filter cases 200 may be provided, and the plurality of filter cases 200 may include a first filter case 201 and a second filter case 202.

The first filter case 201 and the second filter case 202 may be detachably mounted on the frame 300 independently. For example, the first filter case 201 may be separated from the frame 300 even when the second filter case 202 is mounted on the frame 300. In addition, the first filter case 201 and the second filter case 202 may be mounted on the frame 300 at different positions. The first filter case 201 and the second filter case 202 may each accommodate a plurality of filters 20 and accommodate different types of filters 20. For example, the first filter case 201 may accommodate a first filter 21 and a fourth filter 24, which will be described later, and the second filter case 202 may accommodate a second filter 22 and a third filter 23, which will be described later.

Meanwhile, the first filter case 201 and the second filter case 202 may each accommodate a plurality of filters 20 with similar replacement cycles. For example, an average replacement cycle of some filters 20 accommodated in the first filter case 201 among the plurality of filters 20 may be shorter than an average replacement cycle of other filters 20 accommodated in the second filter case 202 among the plurality of filters 20. As a more detailed example, the first filter case 201 may accommodate the first filter 21 and the fourth filter 24 with similar replacement cycles, and the second filter case 202 may accommodate the second filter 22 and the third filter 23 with similar replacement cycles. In this case, the average replacement cycle of the first filter 21 and the fourth filter 24 may be 6 months, and the average replacement cycle of the second filter 22 and the third filter 23 may be shorter than 6 months. In addition, the filter 20 with the longest replacement cycle among some filters 20 accommodated in the first filter case 201 may have a replacement cycle shorter than that of the filter 20 with the shortest replacement cycle among other filters 20 accommodated in the second filter case 202. For example, when the replacement cycle of the fourth filter 24 having the replacement cycle longer than that of the first filter 21 is 7 months and the replacement cycle of the third filter 23 having the replacement cycle shorter than that of the second filter 22 is 11 months, the replacement cycle of the fourth filter 24 may be shorter than the replacement cycle of the third filter 23. Meanwhile, in the drawing according to the present embodiment, two filters are illustrated as being accommodated in the first filter case 201 and the second filter case 202, but only one filter may be accommodated. In addition, the filters accommodated in the first filter case 201 may be defined as a first filter group, and the filters accommodated in the second filter case 202 may be defined as a second filter group.

In this way, the first filter case 201 and the second filter case 202 may manage the filters 20 more efficiently by accommodating the plurality of filters 20 with similar replacement cycles.

Meanwhile, each of the first filter case 201 and the second filter case 202 may include a housing portion 210 and a connector portion 220.

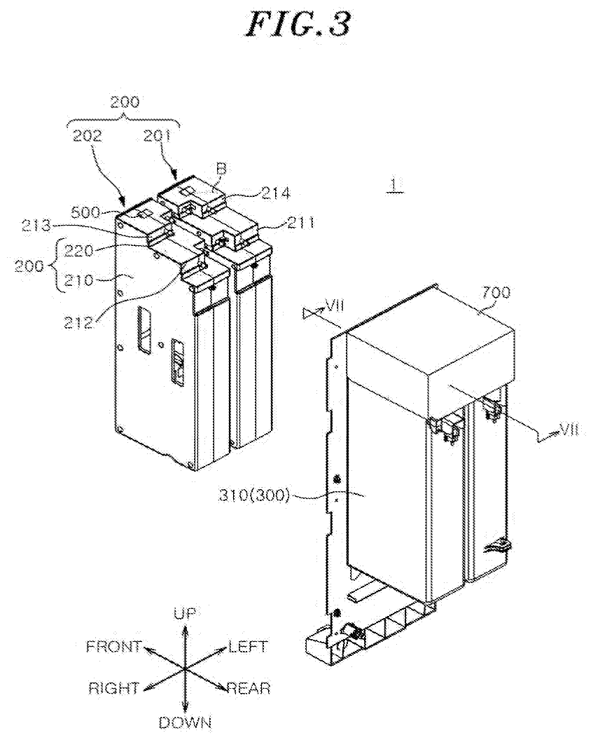

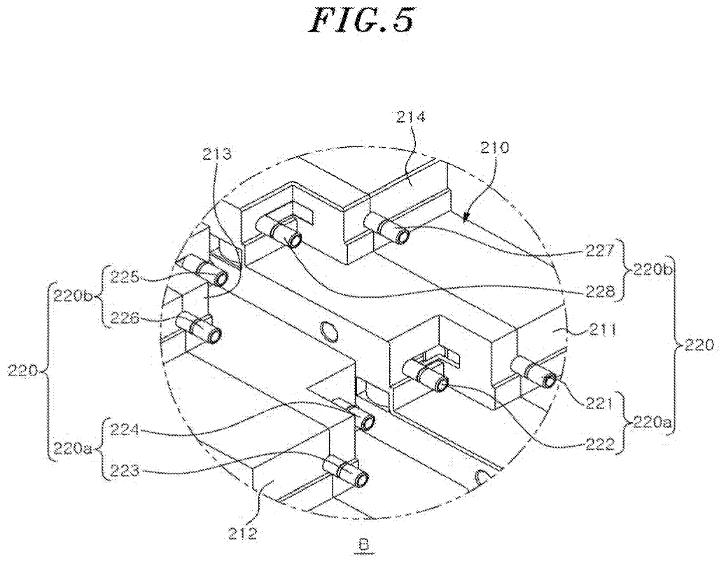

Referring to FIGS. 3 and 5, the housing portion 210 may accommodate a filter 20, and the filter 20 accommodated inside the housing portion 210 may be fixed to the housing portion 210. The front surface of this housing portion 210 may be selectively opened by a cover, and the filter 20 may be accommodated in the housing portion 210 through the open front surface. In addition, one or more steps 211, 212, 213, and 214 may be formed on the upper portion of the housing portion 210, and the connector portion 220 may be supported by one or more steps 211, 212, 213, and 214. One or more of steps 211, 212, 213, and 214 may be provided in plural numbers.

Hereinafter, the steps formed in the housing portion 210 of the first filter case 201 may be referred to as a first step 211 and a fourth step 214, and the steps formed in the housing portion 210 of the second filter case 202 may be referred to as a second step 212 and a third step 213.

The first step 211 may support a first filter inlet connector 221 and a first filter outlet connector 222, which will be described later.

The second step 212 may support a second filter inlet connector 223 and a second filter outlet connector 224, which will be described later.

The third step 213 may support a third filter inlet connector 225 and a third filter outlet connector 226, which will be described later. The third step 213 may be formed above the second step 212.

The fourth step 214 may support a fourth filter inlet connector 227 and a fourth filter outlet connector 228, which will be described later. The fourth step 214 may be formed above the first step 211.

The plurality of filters 20 and a connection portion 320 to be described later may communicate with each other by the connector portion 220. This connector portion 220 may be connected to the plurality of filters 20 accommodated in the housing portion 210. In addition, the connector portion 220 may be open toward the connection portion 320. The connector portion 220 may include a first connector portion 220a and a second connector portion 220b.

The first connector portion 220a of the first filter case 201 may include a first filter inlet connector 221 and a first filter outlet connector 222.

The first filter inlet connector 221 may be connected to a first filter inlet connection port 321, which will be described later. This first filter inlet connector 221 may be connected to the first filter 21 above the first filter 21. In addition, the first filter outlet connector 222 may be connected to the first filter outlet connection port 322, which will be described later.

The second connector portion 220b of the first filter case 201 may be supported by one or more steps 211, 212, 213, and 214 to be spaced apart from the first connector portion 220a of the first filter case 201 in the up-down direction. In addition, the second connector portion 220b of the first filter case 201 may include a fourth filter inlet connector 227 and a fourth filter outlet connector 228.

The fourth filter inlet connector 227 may be connected to a fourth filter inlet connection port 327, which will be described later. This fourth filter inlet connector 227 may be connected to the fourth filter 24 above the fourth filter 24. In addition, the fourth filter outlet connector 228 may be connected to a fourth filter outlet connection port 328, which will be described later.

The first connector portion 220a of the second filter case 202 may include a second filter inlet connector 223 and a second filter outlet connector 224.

The second filter inlet connector 223 may be connected to a second filter inlet connection port 323, which will be described later. This second filter inlet connector 223 may be connected to the second filter 22 above the second filter 22. In additionally, the second filter outlet connector 224 may be connected to a second filter outlet connection port 324, which will be described later.

The second connector portion 220b of the second filter case 202 may be supported by one or more steps 211, 212, 213, and 214 to be separated from the first connector portion 220a of the second filter case 202 in the up-down direction. In addition, the second connector portion 220b of the second filter case 202 may include a third filter inlet connector 225 and a third filter outlet connector 226.

The third filter inlet connector 225 may be connected to a third filter inlet connection port 325, which will be described later. In addition, the third filter outlet connector 226 may be connected to a third filter outlet connection port 326, which will be described later. The third filter discharge connector 226 may be connected to the third filter 23 above the third filter 23.

Meanwhile, the first filter inlet connector 221, the first filter outlet connector 222, the fourth filter inlet connector 227, and the fourth filter outlet connector 228 may be provided in the first filter case 201. In addition, the second filter inlet connector 223, the second filter outlet connector 224, the third filter inlet connector 225, and the third filter outlet connector 226 may be provided in the second filter case 202.

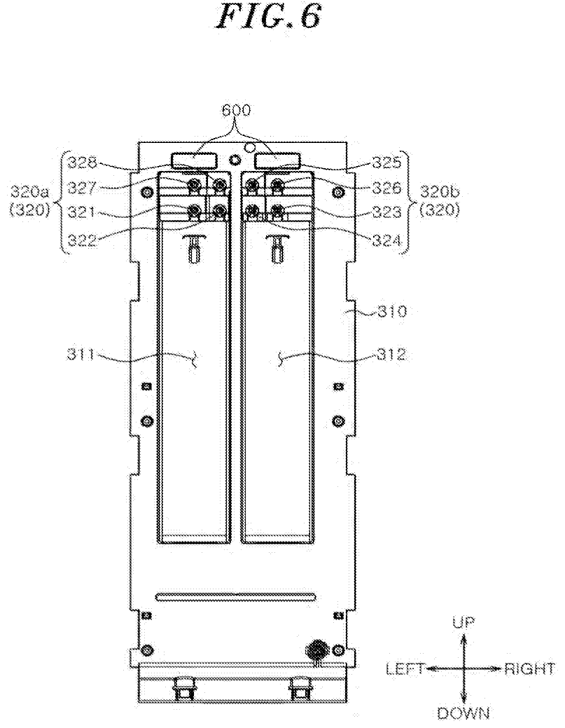

Referring to FIGS. 2 and 6, the filter case 200 may be mounted on the frame 300 to be separable. In addition, the upper portion of the frame 300 may support a valve module 700. The frame 300 may form a space in which the filter case 200 is accommodated. For example, a first accommodating space 311 in which the first filter case 201 is accommodated and a second accommodating space 312 in which the second filter case 202 is accommodated may be formed in the frame 300. The first accommodating space 311 and the second accommodating space 312 are open toward the front, and may be formed to be symmetrical to each other when viewed from the front.

The plurality of filters 20 and the valve module 700 may communicate with each other by the connection portion 320. One side of the connection portion 320 may be connected to the connector portion 220 and the other side may be connected to the valve module 700. In addition, the connection portion 320 may be supported by the frame portion 310 and may be exposed forward through the first accommodating space 311 and the second accommodating space 312. The connection portion 320 may include a first connection portion 320a and a second connection portion 320b.

The first connection portion 320a may be connected to the connector portion 220 of the first filter case 201. The first connection portion 320a may be disposed to be exposed within the first accommodating space 311, and the first connection portion 320a may be disposed to be biased to one side in the first accommodating space 311 in the left-right direction when viewed from the front. The first connection portion 320a may include the first filter inlet connection port 321, the first filter outlet connection port 322, the fourth filter inlet connection port 327, and the fourth filter outlet connection port 328.

The first filter inlet connection port 321 may communicate with the first filter 21 through the first filter inlet connector 221. In addition, the first filter outlet connection port 322 may communicate with the first filter 21 through the first filter outlet connector 222.

The fourth filter inlet connection port 327 may communicate with the fourth filter 24 through the fourth filter inlet connector 227. In addition, the fourth filter outlet connection port 328 may communicate with the fourth filter 24 through the fourth filter outlet connector 228.

The second connection portion 320b may be connected to the connector portion 220 of the second filter case 202. The second connection portion 320b may be disposed to be exposed within the second accommodating space 312. In addition, the second connection portion 320b may be disposed to be biased toward one side of the second accommodating space 312 in the left-right direction when viewed from the front. The second connection portion 320b may include the second filter inlet connection port 323, the second filter outlet connection port 324, the third filter inlet connection port 325, and the third filter outlet connection port 326.

The second filter inlet connection port 323 may communicate with the second filter 22 through the second filter inlet connector 223. In addition, the second filter water outlet connection port 324 may communicate with the second filter 22 through the second filter water outlet connector 224.

The third filter inlet connection port 325 may communicate with the third filter 23 through the third filter inlet connector 225. In additionally, the third filter outlet connection port 326 may communicate with the third filter 23 through the third filter outlet connector 226.

Meanwhile, the first connection portion 320a may be disposed at a position corresponding to the first accommodating space 311. In this case, the first connection portion 320a may be connected to the first filter 21 and the fourth filter 24 when the first filter case 201 is mounted in the first accommodating space 311. In addition, the second connection portion 320b may be disposed at a position corresponding to the second accommodating space 312. In this case, the second connection portion 320b may be connected to the second filter 22 and the third filter 23 when the second filter case 202 is mounted in the second accommodating space 312.

In addition, the first connection portion 320a and the second connection portion 320b may be disposed in the frame portion 310 so as to be symmetrical to each other with respect to the center of the frame portion 310 when viewed from the front. In this case, the connector portion 220 of the first filter case 201 may be prevented from being connected to the second connection portion 320b, and the connector portion 220 of the second filter case 202 may be prevented from being connected to the first connection portion 320a. In other words, the first filter case 201 and the second filter case 202 may be prevented from being mounted on the frame 300 with their positions exchanged.

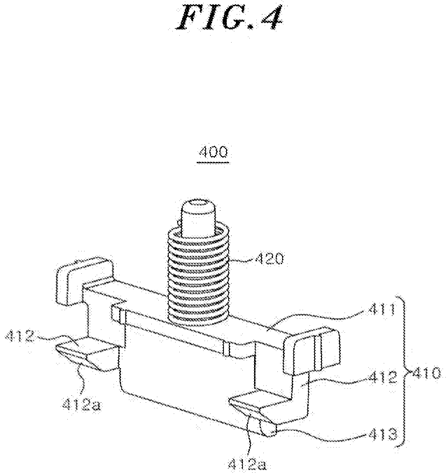

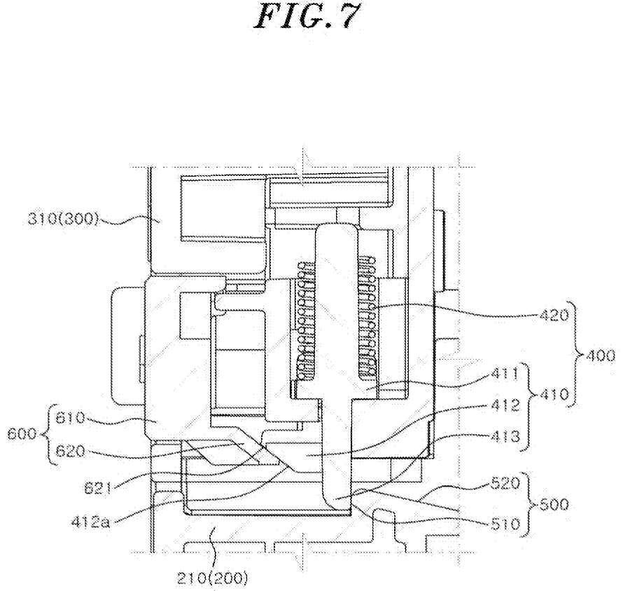

Referring to FIGS. 4 and 7, the locking device 400 can prevent the filter case 200 from being separated from the frame 300 when the filter case 200 is mounted on the frame 300. The locking device 400 may be placed in either a locking state or an unlocking state. In the present specification, the locking state of the locking device 400 is a state in which the locking device 400 is caught by the latch 500 to prevent the filter case 200 from being separated from the frame 300. In addition, the unlocking state of the locking device 400 is a state in which the locking device 400 does not interfere with the latch 500 and allows the filter case 200 to be separated from the frame 300.

The locking device 400 may be provided in either the filter case 200 or the frame 300, and for example, may be provided in the frame 300. In the present specification, the latch 500 is described as being provided in the filter case 200, and the locking device 400 is described as being provided in the frame, but this is only an example and does not limit the present disclosure. Accordingly, the locking device 400 is provided in the filter case 200 and may selectively interfere with the latch 500 provided in the frame 300.

Meanwhile, the locking device 400 may include a locking member 410 and an elastic member 420.

The locking member 410 may be selectively caught on the latch 500, and it can prevent the filter case 200 from being separated by being caught on the latch 500. For example, referring to FIG. 7, the locking member 410 interferes with the latch 500 when the locking device 400 is in the locking state, and thus, it is possible to prevent the filter case 200 from being separated from the frame 300.

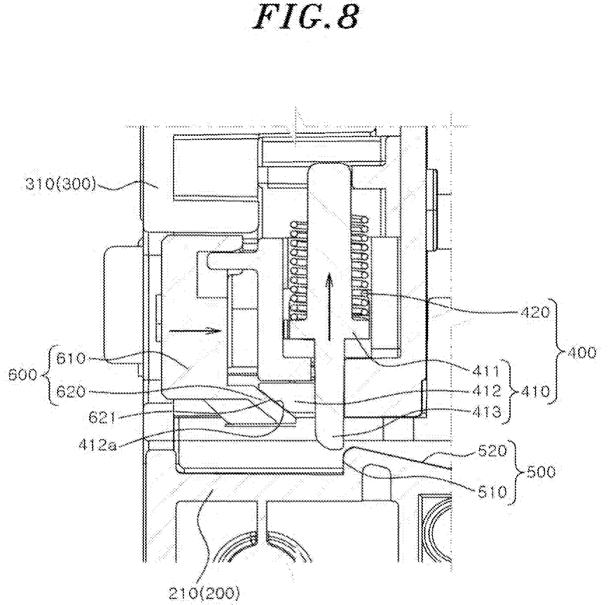

The locking member 410 may be switched from any one of the locking state or the unlocking state to the other by moving the push member 600. For example, referring to FIG. 8, when the push member 600 moves toward the locking device 400, the locking member 410 moves in a direction away from the latch 500. In this case, the locking device 400 switches from the locking state to the unlocking state, and the locking member 410 is spaced apart from the latch 500 by moving in a direction away from the latch 500. In addition, the locking member 410 may allow the filter case 200 to be separated from the frame 300 by being separated from the latch 500 when the locking device 400 is in the unlocking state.

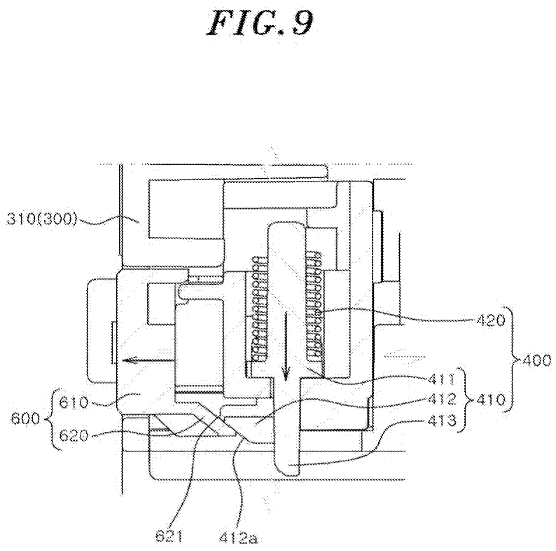

As another example, referring to FIG. 9, when the push member 600 moves in the direction away from the locking device 400, the locking member 410 moves in a direction toward the latch 500. In this case, the locking device 400 switches from the unlocking state to the locking state, and the locking member 410 moves in the direction toward the latch 500 and is caught in the latch 500.

Meanwhile, referring again to FIGS. 4 and 7, the locking member 410 may include a locking body portion 411, a rib portion 412, and an interference portion 413.

The locking body portion 411 may support the rib portion 412 and the interference portion 413, and may support the elastic member 420. The locking body portion 411 may be supported by the frame 300 to be relatively movable with respect to the frame 300. In addition, the locking body portion 411 may be formed integrally with the rib portion 412 and the interference portion 413.

The rib portion 412 may move in the up-down direction by moving the push member 600. The rib portion 412 may extend from the locking body portion 411 toward the push member 600. For example, the rib portion 412 may protrude forward from the locking body portion 411. In addition, when the push guide portion 620 moves in the front-rear direction, the rib portion 412 may move in the up-down direction while a bottom surface of the rib portion is supported by the upper surface of the push guide portion 620. The rib portion 412 may be formed such that at least a portion of the bottom surface is inclined upward. For example, the rib portion 412 has a rib surface 412a, and the rib surface 412a is extended to be inclined upward.

As a more detailed example, when the push member 600 moves toward the locking device 400, the rib surface 412a is supported by a guide surface 621, which will be described later. In addition, while the push member 600 is moved toward the locking device 400, the rib surface 412a may move upward along the guide surface 621. As another example, when the push member 600 moves in a direction away from the locking device 400, the rib portion 412 may move downward along the guide surface 621. By moving the rib portion 412, the locking body portion 411 and the interference portion 413 may move in the up-down direction.

The interference unit 413 may selectively interfere with the latch 500. For example, the interference unit 413 may be caught on a wall surface 510 of the latch 500, which will be described later, when the locking device 400 is placed in the locking state. In this case, the interference portion 413 is in surface contact with the wall surface 510. As another example, the interference unit 413 may be spaced upward from the latch 500 when the locking device 400 is in the unlocking state. In addition, the interference portion 413 may move along an inclined surface 520 of the latch 500, which will be described later, when the filter case 200 is mounted in the accommodating space inside the housing portion 210. In this case, the locking device 400 switches from the locking state to the unlocking state by moving the latch 500 even when the push member 600 does not move. The interference portion 413 may extend downward from the locking body portion 411.

The elastic member 420 may provide a restoring force to the locking member 410. When the locking device 400 is placed in the unlocking state, the elastic member 420 may provide a restoring force to the locking member 410 so that the locking member 410 moves in the direction in which the locking member is placed in the locking state. In other words, the elastic member 420 may provide a restoring force to the locking member 410 so that the locking device 400 moves downward when the locking device 400 is in the unlocking state. For example, the elastic member 420 may be a compression spring that provides an elastic force so that the locking member 410 moves toward the latch 500. The elastic member 420 may be more compressed to have a greater restoring force when the locking device 400 is placed in the unlocking state than when the locking device is placed in the locking state. In addition, the elastic member 420 may have one side supported by the locking body portion 411 and the other side supported by the frame 300.

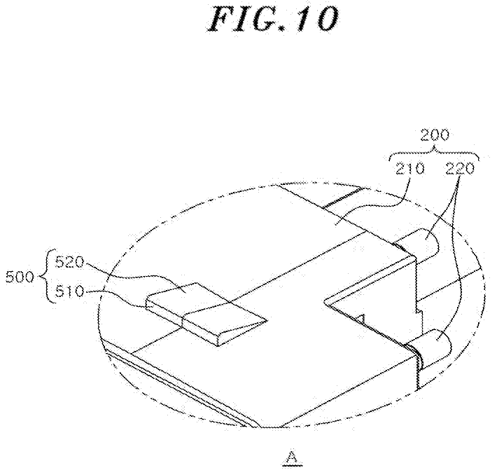

Referring to FIGS. 7 and 10, the latch 500 may be selectively caught on the locking device 400. The latch 500 may be provided in any one of the filter case 200 or the frame 300. For example, the latch 500 may be provided on the upper surface of the filter case 200 and may protrude upward from the upper surface of the filter case 200. The latch 500 may include the wall surface 510 and the inclined surface 520.

The wall surface 510 may extend upward from the upper surface of the filter case 200. For example, the wall surface 510 may extend perpendicular to the upper surface of the filter case 200. The wall surface 510 may be stably caught on the locking device 400 by making surface contact with the interference portion 413 of the locking device 400 placed in the locking state.

The inclined surface 520 may be inclined downward and extend from the wall surface 510. For example, the inclined surface 520 may extend in a direction that is different from the direction in which the upper surface of the filter case 200 is extended. The inclined surface 520 may guide the movement of the interference portion 413 such that when the filter case 200 is mounted on the frame 300, the interference portion 413 of the locking device 400 moves upward along the inclined surface 520.

Referring to FIG. 7, the push member 600 may move the locking device 400. The push member 600 may be provided in any one of the filter case 200 and the frame 300. In addition, the push member 600 may be supported to be movable relative to any one of the filter case 200 and the frame 300. For example, the push member 600 may be supported to be movable relative to the frame 300. In addition, when the push member is pressed by a user, the push member may move the locking device 400 by moving toward the locking device 400. The push member 600 may include a push body portion 610 and a push guide portion 620.

The push body portion 610 may be supported by the frame 300 to be movable relative to the frame 300. For example, the push body portion 610 may be supported by the frame 300 to be movable in the front-rear direction. The push body portion 610 may support the push guide portion 620.

The push guide portion 620 may move the locking device 400 by moving in response to the push body portion 610. The push guide portion 620 may extend from the push body portion 610 toward the locking member 410. In addition, the push guide portion 620 may be formed such that at least a portion of the upper surface is inclined downward. For example, the push guide portion 620 has a guide surface 621, and the guide surface 621 may extend to be inclined downward.

As a more detailed example, referring to FIG. 8, when the push member 600 moves toward the locking device 400, the guide surface 621 supports the rib surface 412a. In additionally, while the push member 600 moves toward the locking device 400, the rib portion 412 moves upward along the guide surface 621, and the locking member 410 moves upward. In this case, the locking device 400 may be placed in the unlocking state. As another example, referring to FIG. 9, while the push member 600 moves in the direction away from the locking device 400, the rib portion 412 moves downward along the guide surface 621, and the locking member 410 moves downward. In this case, the locking device 400 may be placed in the locking state.

The valve module 700 may control the flow of water by selectively opening and closing the flow path for water to flow. The valve module 700 may include a plurality of valves, and each of the plurality of valves may selectively open and close the flow path to control the flow of water. In addition, the valve module 700 may be supported by the upper portion of the frame 300. The valve module 700 may communicate with the connection portion 320, and the water may flow from the valve module 700 to the plurality of filters 20 or from the plurality of filters 20 to the valve module 700 through the connection portion 320.

The filter 20 may filter water and provide purified water. A plurality of filters 20 may be provided, and the plurality of filters 20 may be accommodated in the filter case 200. The plurality of filters 20 may include a first filter 21, a second filter 22, a third filter 23, and a fourth filter 24.

The first filter 21 may filter dirt, rust, and dust contained in water, and adsorb and remove chlorine and organic chemicals. For example, the first filter 21 may be a NeoSense filter. The first filter 21 may have a replacement cycle of 5 to 7 months. In addition, the first filter 21 may be accommodated in the first filter case 201.

The second filter 22 may filter fine particles contained in water and filter harmful substances such as E. coli, germs, and bacteria. For example, the second filter 22 may be a nanotrap filter. The second filter 22 may have a replacement cycle of 11 to 13 months. In addition, the second filter 22 may be accommodated in the second filter case 202.

The third filter 23 may remove chlorine remaining in the water and deodorize odors. For example, the third filter 23 may be an innocence filter. The third filter 23 may have a replacement cycle of 11 to 13 months. In addition, the third filter 23 may be accommodated in the second filter case 202.

The fourth filter 24 may prevent scale from being created by removing hard substances contained in water. For example, the fourth filter 24 may be an anti-scale filter. The fourth filter 24 may have a replacement cycle of 5 to 7 months. In addition, the fourth filter 24 may be accommodated in the first filter case 201.

In this way, in the water purifier assembly 1 according to one embodiment of the present disclosure, it is possible to replace the plurality of filters 20 at once by simply removing and replacing the single filter case 200 accommodating the plurality of filters 20 from the frame 300.

In addition, the water purifier assembly 1 selectively fixes the filter case 200 which accommodates the plurality of filter 20 through the locking device 400. Accordingly, it is possible to fix a plurality of filters 20 to the frame 300 even when the number of locking devices 400 is less than that of the filters.

In addition, by grouping filters with similar replacement cycles among the plurality of filters 20 and accommodating the grouped filters in one filter case 200, it is possible to reduce the inconvenience of having to separate the filter case 200 from the frame 300 for each replacement cycle.

In addition, the first connection portion 320a and the second connection portion 320b are disposed to be biased to one side with respect to the first accommodating space 311 and the second accommodating space 312, respectively, and thus, it is possible to prevent the first filter case 201 and the second filter case 202 from being mounted on the frame 300 at different positions.

Although the embodiments of the present disclosure have been described above as specific embodiments, this is merely an example, and the present disclosure is not limited thereto, and should be construed as having the widest scope following the technical idea disclosed in the present specification. A person skilled in the art may implement a pattern of a shape not specified by combining/substituting the disclosed embodiments, but this also does not depart from the scope of the present disclosure. In addition, a person skilled in the art can easily change or modify the embodiments disclosed based on the present specification, and it is clear that such changes or modifications also fall within the scope of the present disclosure.

What is claimed is:

1. A water purifier comprising:
a filter case configured to accommodate a plurality of filters;
a frame on which the filter case is mounted to be separable;
a latch provided in any one of the filter case and the frame; and
a locking device configured to be placed in any one of a locking state where the filter case is prevented from being separated from the frame and an unlocking state in which the filter case is allowed to be separated from the filter case, when the filter case is mounted on the frame,
wherein the locking device includes a locking member that is provided in the other of the filter case and the frame, interferes with the latch when the locking member is in the locking state, and moves in a direction away from the latch when the locking member is switched from the locking state to the unlocking state.

2. The water purifier of claim 1, further comprising a push member movably supported relative to any one of the filter case and the frame,
wherein the locking member moves in the direction away from the latch when the push member is moved toward the locking device, and moves in a direction toward the latch when the push member is moved in a direction away from the locking device.

3. The water purifier of claim 2, wherein the push member includes:
a push body portion; and
a push guide portion extending from the push body portion toward the locking member and formed such that at least a portion of an upper surface is inclined downward,
wherein the locking member includes:
a locking body portion; and
a rib portion extending from the locking body portion toward the push member and formed such that at least a portion of a bottom surface is inclined upward, and
wherein the rib portion moves in an up-down direction with the bottom surface supported by the upper surface of the push guide portion when the push guide portion moves in a front-rear direction.

4. The water purifier of claim 1, wherein the locking device includes an elastic member, and
wherein the elastic member provides restoring force so that the locking member switches from the unlocking state to the locking state, and the restoring force becomes greater when the locking member is placed in the unlocking state than when placed in the locking state.

5. The water purifier of claim 1, wherein the latch includes a wall surface extending upward from an upper surface of the filter case and an inclined surface extending obliquely downward from the wall surface, and
wherein the locking member is in surface contact with the wall surface when the locking member is placed in the locking state.

6. A water purifier assembly comprising:
a plurality of filters configured to filter water to provide purified water; and
a water purifier on which the filter is mounted to be separable,
wherein the water purifier includes:
a filter case configured to accommodate the plurality of filters;
a frame on which the filter case is mounted to be separable;
a latch provided in any one of the filter case and the frame; and
a locking device configured to be placed in any one of a locking state where the filter case is prevented from being separated from the frame and an unlocking state in which the filter case is allowed to be separated from the filter case, when the filter case is mounted on the frame, and
wherein the locking device includes a locking member that is provided in the other of the filter case and the frame, interferes with the latch when the locking member is in the locking state, and moves in a direction away from the latch when the locking member is switched from the locking state to the unlocking state.

7. The water purifier assembly of claim 6, wherein the filter case includes:
a first filter case configured to accommodate a first filter group including some of the plurality of filters; and
a second filter case configured to accommodate a second filter group including others of the plurality of filters, and
wherein an average replacement cycle of the filters of the first filter group is shorter than an average replacement cycle of the filters of the second filter group.

8. The water purifier assembly of claim 7, wherein the filter with the longest replacement cycle among the filters in the first filter group has a shorter replacement cycle than the filter with the shortest replacement cycle among the filters in the second filter group.

9. The water purifier assembly of claim 6, wherein the filter case includes:
a first filter case configured to accommodate a first filter group including some of the plurality of filters; and
a second filter case configured to accommodate a second filter group including others of the plurality of filters,
wherein the frame includes:
a frame portion having a first accommodating space opened toward the front and accommodating the first filter case and a second accommodating space opened toward the front and accommodating the second filter case;
a first connection portion disposed to be biased toward one side in the first accommodating space in a left-right direction when viewed from the front and communicating with the filter of the first filter group; and
a second connection portion disposed to be biased toward one side in the second accommodating space in the left-right direction when viewed from the front and communicating with the filter of the second filter group, and
wherein the first connection portion and the second connection portion are disposed on the frame portion so that the first connection portion and the second connection portion are symmetrical to each other with respect to a center of the frame portion when viewed from the front.

10. The water purifier assembly of claim 6, wherein the filter case includes:
a connector portion including a first connector portion connected to any one of the plurality of filters and a second connector portion connected to another one of the plurality of filters; and
a housing portion configured to accommodate the plurality of filters and support the first connector portion and the second connector portion,
wherein one or more steps are formed in the housing portion, and
wherein the first connector portion and the second connector portion are supported by the one or more steps so as to be spaced apart from each other in an up-down direction.
